(19) United States
(12) Patent Application Publication
(10) Pub. No.: US 2013/0086284 A1
(43) Pub. Date: Apr. 4, 2013

(54) NETWORK INTERFACE BASED ON DETECTION OF INPUT COMBINATION INTERFACE

(71) Applicants: Charles N. Shaver, Cypress, TX (US); Shih-Wei Sun, (US)

(72) Inventors: Charles N. Shaver, Cypress, TX (US); Shih-Wei Sun, (US)

(21) Appl. No.: 13/250,399

(22) Filed: Sep. 30, 2011

(51) Int. Cl. G06F 3/00

(52) U.S. Cl. 710/18

(57) ABSTRACT

A computing device includes an input combination interface and a network interface. The network interface is enabled and/or disabled based on the usage of the input combination interface.

### BACKGROUND

Computing devices may include various components such as interfaces that may affect power usage. However, such a computing device may not be operable in environments where external power is not available or desirable.

### BRIEF DESCRIPTION OF THE DRAWINGS/FIGURES

FIG. 1 is a block diagram of a computing device including a switching circuit according to an example.

FIG. 2 is a block diagram of a computing device including a switching circuit according to an example.

FIG. 3 is a block diagram of a computing device including a switching circuit according to an example.

FIG. 4 is a block diagram of a computing device including a switching circuit according to an example.

FIG. 5 is a block diagram of a computing device including a switching circuit according to an example.

FIG. 6 is a circuit diagram of a power switch according to an example.

FIG. 7 is a circuit diagram of a network switch according to an example.

FIG. 8 is a flow chart based on a method of operating a computing device according to an example.

FIG. 9 is a flow chart based on a switching circuit according to an example.

The present examples will now be described with reference to the accompanying drawings. In the drawings, like reference numbers may indicate identical or functionally similar elements.

### DETAILED DESCRIPTION

A computing device may include interfaces to receive data and/or power. Interfaces may include network interfaces and/or combination interfaces such as Universal Serial Bus (USB) interfaces or other interfaces and/or ports of a computing device that may be associated with both power and data. Such interfaces may also include external Serial Advanced Technology Attachment (eSATA) interfaces, and may be used to interact with another device, e.g., a server/host. The computing device may be a stand-alone device, such as a thin client or zero client that interacts with the server in a shared resource computing system. The computing device may be associated with a power source that may be coupled to provide power to the computing device, such as a battery source or external power source. The computing device may provide a familiar, reliable computing experience that transparently exchanges resources with the server based on a data connection of a combination interface and/or network interface.

The computing device may conserve resources by selectively disabling the network interface. For example, the computing device may disable the network interface when an input combination interface is in use. For example, usage of a combination interface may include interaction with another device. Usage may include a USB connection being established with another device. The other device may be a local device, within a distance to the computing device to enable coupling via a cable, and/or within a distance to connect wirelessly (e.g., via wireless local area network (WLAN), via inductive power coupling, and the like). A device may include another computing device, a host, a server, a client, or other devices capable of interacting with a combination interface. Usage of the combination interface may include a physical coupling with the combination interface and a cable, a voltage and/or power received at the combination interface, data received at the combination interface, and other forms of connections associated with the combination interface. The computing device may also include an external power interface to receive external power to enable a high power mode of the computing device. The computing device may determine the availability of received power, such as power from an external alternating current (AC) adapter or direct current (DC) source such as a battery, based on detection of a voltage or power at a power interface associated with the received power. The computing device may prioritize usage of the received power, and provide system power in the high power mode based on the received power without drawing power from the input combination interface. The high power mode may include high power output for various components including output combination interfaces, and may support high current components such as USB-powered external hard drives, scanners, printers, and other components that draw high current from output combination interfaces. Accordingly, the computing device may provide enhanced operation and power/cost savings.

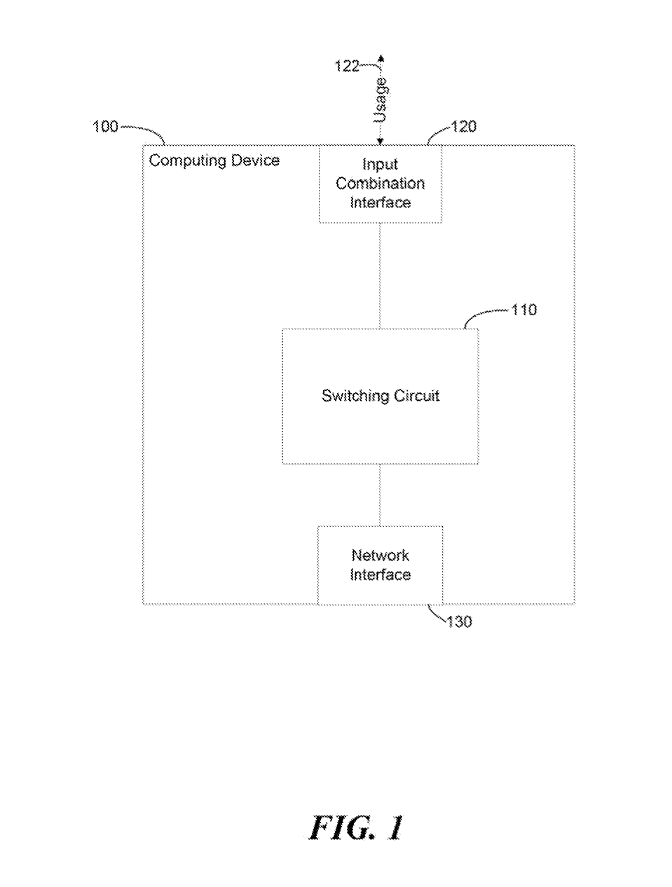

FIG. 1 is a block diagram of a computing device 100 including a switching circuit 110 according to an example. The computing device 100 also includes an input combination interface 120 connected to the switching circuit 110, and a network interface 130 connected to the switching circuit 110. Usage 122 of the input combination interface 120 may be determined by the switching circuit 110. Usage 122 may be detected based on physical interactions with a plug, receiving a voltage/power at the input combination interface 120, receiving data at the input combination interface 120, and/or by using other techniques to indicate usage 122. The input combination interface 120 may be a USB interface, an eSATA interface, or other interfaces associated with power and data. The input combination interface 120 may be a data interface coupled with a power interface, such as a wireless network (WLAN) for data and an inductive power coupling for power, and/or Power over Ethernet (PoE) interfaces.

The input combination interface 120 may be a type Standard-B USB interface, as specified in the USB specification, and may be other interface types including proprietary interfaces to provide data communication and power transfer. The network interface 130 may be a registered jack type 45 (RJ45), WLAN, or other interface to provide bidirectional communication. The computing device 100 may be externally powered, e.g., via an alternating current (AC) adapter to provide direct current (DC) to the computing device. External power may be used regardless of whether the input combination interface 120 is being used (usage 122). When the input combination interface 120 is used, the network interface 130 may be disabled, regardless of whether external power is provided. Thus, usage 122 may be prioritized over the network interface 130, even if external power is applied.

The computing device 100 may include a circuit board to implement the various components. The network interface 130 may be integrated as part of the circuit board of the computing device 100, and may be enabled/disabled. In another example, the network interface 130 may be an add-on card or a peripheral device that is coupled to an interface of the computing device 100. Accordingly, the computing device 100 may be associated with the use of a computing device chassis design that may be used to satisfy various design parameters. The computing device 100 may be used even in applications where only USB power is available to power the computing device 100 via input combination interface 120 (whereby the network interface 130 may be disabled to conserve power and operate within a specified power envelope).

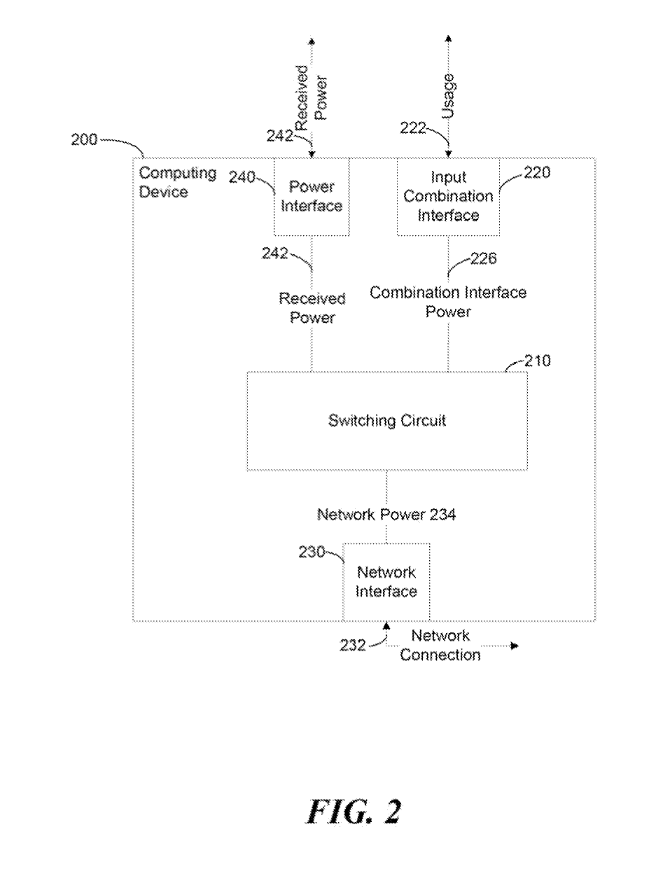

FIG. 2 is a block diagram of a computing device 200 including a switching circuit 210 according to an example. The computing device 200 also may include a power interface 240, input combination interface 220, and network interface 230. The computing device 200 may include other components that are not shown in FIG. 2, such as processor(s), memory, storage, removable media, graphics, audio, input device(s), an operating system (OS), and other components.

The power interface 240 may be associated with received power 242. The input combination interface 220 may be associated with usage 222 and combination interface power 226. The network interface 230 may be associated with network power 234 and network connection 232.

The computing device 200 and the network interface 230 may be powered when received power 242 is present at the power interface 240. Thus, the network interface 230 may connect to another device to transmit/receive data and/or communicate with another device via a network, for example. The network interface 230 may include an interface associated with a local area network (LAN), wireless LAN (WLAN), or other data interfaces including optical data interconnects.

Switching circuit 210 may detect received power 242 from the power interface 240, and enable the network interface 230. For example, the switching circuit 210 may provide network power 234 to power the network interface 230. The switching circuit 210 also may detect usage of the input combination interface 220. For example, the switching circuit 210 may detect combination interface power 226 from the input combination interface 220, indicating that the input combination interface 220 is coupled with a source of power and/or data. In an example, the input combination interface 220 is coupled to a USB device that provides power and/or data via a USB cable/bus. The switching circuit 210 may then disable the network interface 230. Accordingly, the computing device 200 may receive data from another device using the network interface 230 and/or the input combination interface 220, and may selectively disable the network interface 230 when usage 222 of the input combination interface 220 is detected. In an example, the switching circuit 210 may disable network power 234 to the network interface 230, thereby conserving power consumption of the computing device 200.

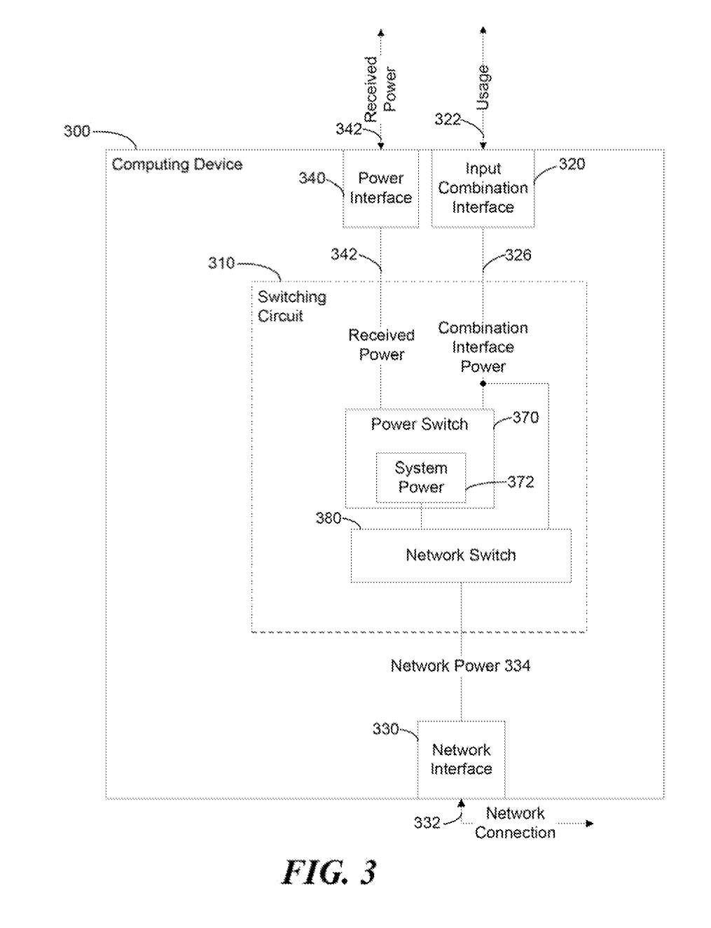

FIG. 3 is a block diagram of a computing device 300 including a switching circuit 310 according to an example. The computing device 300 also may include power interface 340, input combination interface 320, and network interface 330. The computing device 300 may include other components that are not shown in FIG. 3, such as processor(s), memory, storage, removable media, graphics, audio, input device(s), an operating system (OS), and other components.

The power interface 340 may be associated with received power 342. The input combination interface 320 may be associated with usage 322 and combination interface power 326. The network interface 330 may be associated with network power 334 and network connection 332.

The switching circuit 310 may include a power switch 370 and a network switch 380. The power switch 370 may receive received power 342 and combination interface power 326, and provide system power 372. The network switch 380 may receive system power 372 and combination interface power 326, and provide network power 334.

The power switch 370 may provide system power 372 based on received power 342 and/or combination interface power 326. Accordingly, the computing device 300 may provide power and dynamically switch between the received power 342 and/or the combination interface power 326 based on usage 322 of the input combination interface 320. The power switch 370 may disable the network interface 330 by switching off network power 334. Other techniques may be used to disable the network interface 330, such as sending a disable signal to the network interface 330. The network switch 380 may disable network power 334 based on a lack of system power 372, and also may disable network power 334 based on receiving combination interface power 326 and/or an indication of usage 322 of input combination interface 320. Thus, the switching circuit 310 may disable network interface 330 based on available power (whether received power 342 is present) at power interface 340, and based on whether a device is coupled to the input combination interface 320 (or other usage 322 of input combination interface 320).

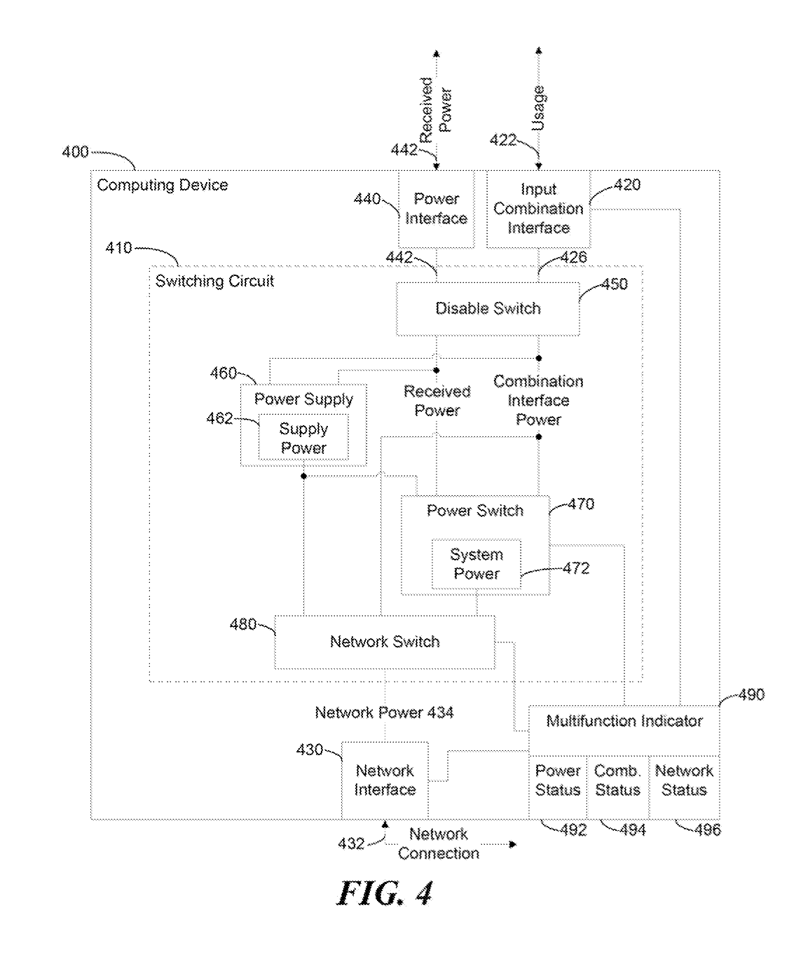

FIG. 4 is a block diagram of a computing device 400 including a switching circuit 410 according to an example. The computing device 400 also may include a power interface 440, input combination interface 420, network interface 430, and multifunction indicator 490. The computing device 400 may include other components that are not shown in FIG. 4, such as processor(s), memory, storage, removable media, graphics, audio, input device(s), an operating system (OS), and other components.

The power interface 440 may be associated with received power 442. The input combination interface 420 may be associated with usage 422 and combination interface power 426. For example, the input combination interface 420 may be a USB interface and usage 422 may be associated with receiving a USB voltage/USB power, although other types of interfaces/received power may be used. The network interface 430 may be associated with network power 434 and network connection 432. The multifunction indicator 490 may be associated with power status 492, input combination interface status 494, and network status 496.

The switching circuit 410 may be associated with disable switch 450, power supply 460, power switch 470, and network switch 480. Disable switch 450 may receive received power 442 from power interface 440, and may receive combination interface power 426 from input combination interface 420. The disable switch 450 may communicate the received power 442, and combination interface power 426 from the input combination interface 420, to the switching circuit 410. The disable switch 450 also may disable the switching circuit 410, and/or may selectively disable components of the computing device 400.

The power supply 460 may receive received power 442 and combination interface power 426 from the disable switch 450. The power supply 460 may provide supply power 462, based on at least one of the received power 442 and/or the combination interface power 426. The power supply 460 may be provided as a pair of cathode connected diodes, for example, wherein received power 442 is received at the anode of one diode, combination interface power 426 is received at the anode of the other diode, and supply power 462 is provided at the common cathode shared by both diodes. The supply power 462 may be output to the power switch 470 and the network switch 480, and may be used throughout the computing device 400. The supply power 462 may be 5 volts (V), for example.

The power switch 470 may receive received power 442 and combination interface power 426 from the disable switch 450. The power switch 470 also may receive supply power 462 from the power supply 460. The power switch 470 may provide system power 472 for components of the device, such as the network switch 480. System power 472 may be provided based on whether at least one of received power 442 and/or combination interface power 426 is available.

Network switch 480 may receive supply power 462 from power supply 460, and system power 472 from power switch 470. In an example, the network switch 480 and the power switch 470 (and other components) may be part of a single switch component. Network switch 480 may receive combination interface power 426 from disable switch 450, and/or may receive an indication whether usage 422 is associated with the input combination interface 420. Based on the usage 422 (e.g., combination interface power 426), the supply power 462, the system power 472, and/or the network switch 480 may selectively provide network power 434 to network interface 430. Thus, network switch 480 may selectively disable network interface 430 based on whether received power 442 is available at power interface 440 and/or whether usage 442 is associated with the input combination interface 420. Network switch 480 may disable network interface 430 based on switching off network power 434, and may disable based on other techniques such as disconnecting network interface 430 from the network connection 432 and/or disconnecting network interface 430 from other connections including internal connections within computing device 400 (e.g., disconnecting from a power bus, a data bus, and the like).

As noted above, the device can include a multifunction indicator 490. The Multifunction indicator 490 may receive a status of computing device 400 (e.g., from power switch 470, network switch 480, network interface 430, input combination interface 420, and other components) and may indicate the status of the computing device 400 using a single multicolor indicator such as a light emitting diode (LED) or other indicator. In other examples, the multifunction indicator may include a plurality of LEDs, each corresponding to a status or a state of the computing device.

The multifunction indicator 490 may indicate a power status 492, a input combination interface status 494, a network status 496, and/or other status information. For example, the multifunction indicator may indicate power status 492 by showing a solid blue light for external power, and a solid amber light for bus power (e.g., when the computing device 400 is powered from a USB bus via the usage 422 while in the absence of received power). Thus, the multifunction indicator 490 may indicate whether the computing device 400 (and/or components associated with the computing device) is operating in a low power mode. The multifunction indicator 490 may indicate input combination interface status 494, for example, by flashing whatever color is used to indicate power status 492 to thereby indicate whether the usage 422 is established. Similarly, network status 496 may be indicated by flashing to indicate whether the network connection 432 is established. Thus, the multifunction indicator 490 may indicate whether the computing device 400 is associating with a host, e.g., associating with the host during a handshaking procedure via the network interface 430, and may indicate whether the computing device 400 is powered by received power and is operating in a high power mode (e.g., supporting a high capacity current load on output USB ports). Additionally, by disabling the network interface 430 when a usage 422 is established (e.g., when the input combination interface is physically coupled with a cable (e.g., USB cable) that connects to a host server, thereby being associated with the host once connected), a single multifunction indicator 490 may provide status information without needing multiple different indicators to address additional status situations such as when the network interface 430 and input combination interface 420 are active simultaneously. In alternate examples, computing device 400 may include a multifunction indicator 490 that may show all possible status combinations of components associated with computing device 400, including components not specifically illustrated in FIG. 4.

The network interface 430 may be associated with a state machine (not shown) whose status may be indicated using the multifunction indicator 490. The state machine associated with the network interface may change the functionality of the multifunction indicator 490, such that the multifunction indicator 490 may indicate a network connection status and a host/server association status using indications that may be similar or identical to indications associated with the input combination interface status. Thus, a user may interpret additional information based on indications from the multifunction indicator 490 and the knowledge of whether the usage 422 is established. For example a blue flashing LED may indicate host association is occurring over the network connection 432. Accordingly, the multifunction indicator 490 may be simplified. e.g., may include two colors, while still being capable of indicating multiple status conditions that would otherwise be associated with a need for additional colors and/or indicators. In an example, the multifunction indicator 490 may show solid amber when the computing device 400 is powered only by USB cable, and solid blue when powered by received power 442. The multifunction indicator 490 may flash blue/off when looking for a host server to which the computing device 400 may associate. The multifunction indicator 490 may flash blue/amber to indicate that it is currently associating with a host server. In alternate examples, additional indications, such as other colors and flash patterns, may be used to communicate additional status information.

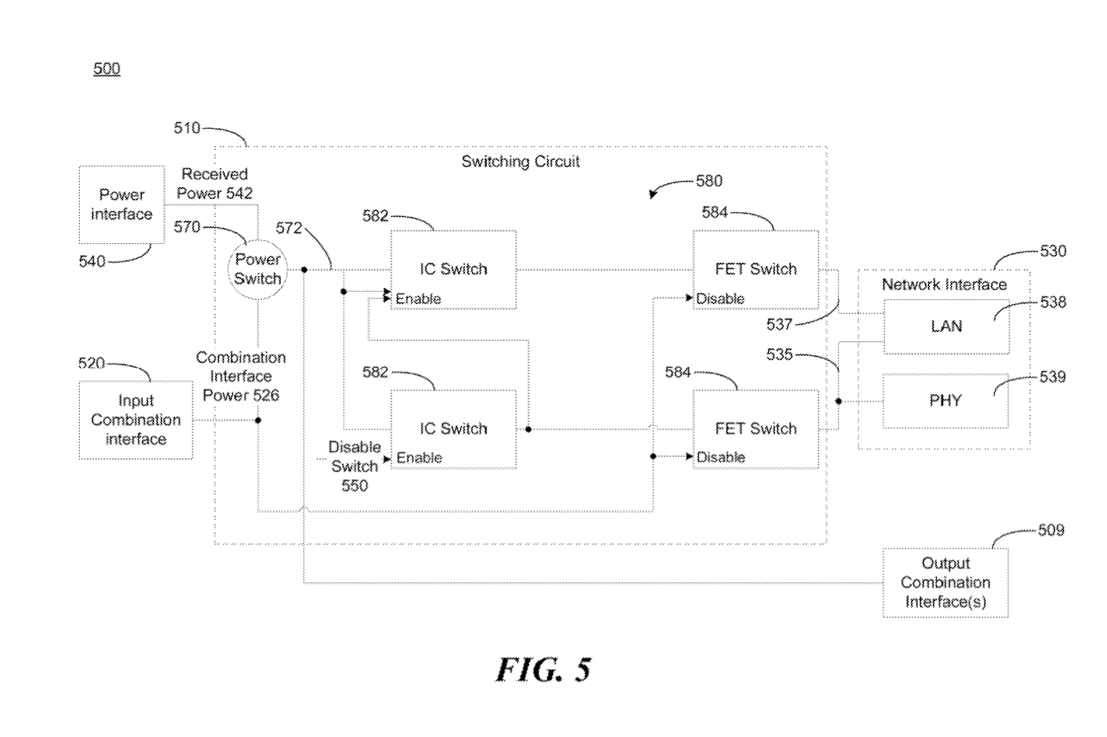

FIG. 5 is a block diagram of a computing device 500 including a switching circuit 510 according to an example. The computing device 500 may also include power interface 540, input combination interface 520, network interface 530 (that may include local area network component (LAN) 538 and physical layer component (PHY) 539), and at least one output combination interface(s) 509. Additional components may be included, such as a display, a processor, memory, a USB hub, an audio component, and others. Components may be associated with high and/or low power modes.

The output combination interface(s) 509 may be output type Standard-A USB connectors as specified in the USB specification, for example, and may include other types of interfaces, including interfaces that are not USB (e.g., serial and/or parallel interfaces, SATA interfaces, proprietary interfaces, etc.). Examples may include 4 or more output USB ports to enable connection with a keyboard, a mouse, and two potentially high-powered devices (external storage device, USB-powered display) when received power 542 is available. When computing device 500 is powered by combination interface power 526, the output combination interfaces may limit support to low-power devices such as the keyboard and mouse.

The switching circuit 510 may include a power switch 570 and a network switch 580 that may include at least one Integrated Circuit (IC) switch(es) 582, and at least one FET switch(es) 584. The switching circuit 510 may receive received power 542 from the power interface 540, and may receive combination interface power 526 from the input combination interface 520. The received power may be distributed among the various components of the computing device 500, e.g., may be distributed as system power 572. Distribution of power, including disconnecting/withholding of power, may be used to selectively disable various components. In alternate examples, components of computing device 500 may be disabled based on techniques other than withholding/disconnecting a device from power.

The power switch 570 may output additional power and information regarding system status that may be transmitted to various components. For example, the power switch 570 may include high current for use by output combination interfaces 509 when received power 542 is available, and may be used to activate enables/disables and/or other logic associated with components.

Output of power switch 570, including system power 572, may be distributed to IC switches 582. Output of power switch 570 also may be distributed directly to components of the computing device 500, such as output combination interface(s) 509 or other components. Other output, such as combination interface power 526 and received power 542, may be distributed to IC switches 582 and other components of computing device 500. IC switches 582 may distribute further signals to the various components of computing device 500. For example, a display and/or processor may receive output from IC switch(es) 582.

An IC switch 582 may include an enable pin. The enable pin may be tied to the input of its IC switch 582, to the output of another IC switch 582, and/or to a component such as disable switch 550. Thus, an IC switch 582 may provide output if it receives input, if another IC switch is providing output, or based on a disable switch 550 or other component. Output from IC switches 582 may be provided directly to components, such as display and/or processor 502, memory 504, and USB hub 506. Output from IC switches 582 also may be provided to components indirectly through FET switch(es) 584. In alternate examples, IC switches 582 and FET switches 584 may be interchangeable, and examples may use switches that are non-IC and/or non-FET.

FET switches 584 may receive input from IC switches 582 and provide output to network interface 530. The IC switches 582 may selectively withhold power from the FET switches 584 based on whether the input combination interface 520 is being used to supply power to the computing device 500. Thus, the FET switches 584 may be disabled by virtue of having power removed from them. The FET switches 584 also may be disabled based on whether combination interface power 526 is present to disable the FET switches 584, for example disabling via a disable pin on each FET switch 584. In an example, presence of combination interface power 526 may disable the FET switches 584, thereby disabling first output network power 535 and second output network power 537 from being sent to LAN 538 and PHY 539 of network interface 530. Network interface 530 may be disabled based on other techniques, such as receiving a disable signal separate from first output network power 535 and second output network power 537, for example.

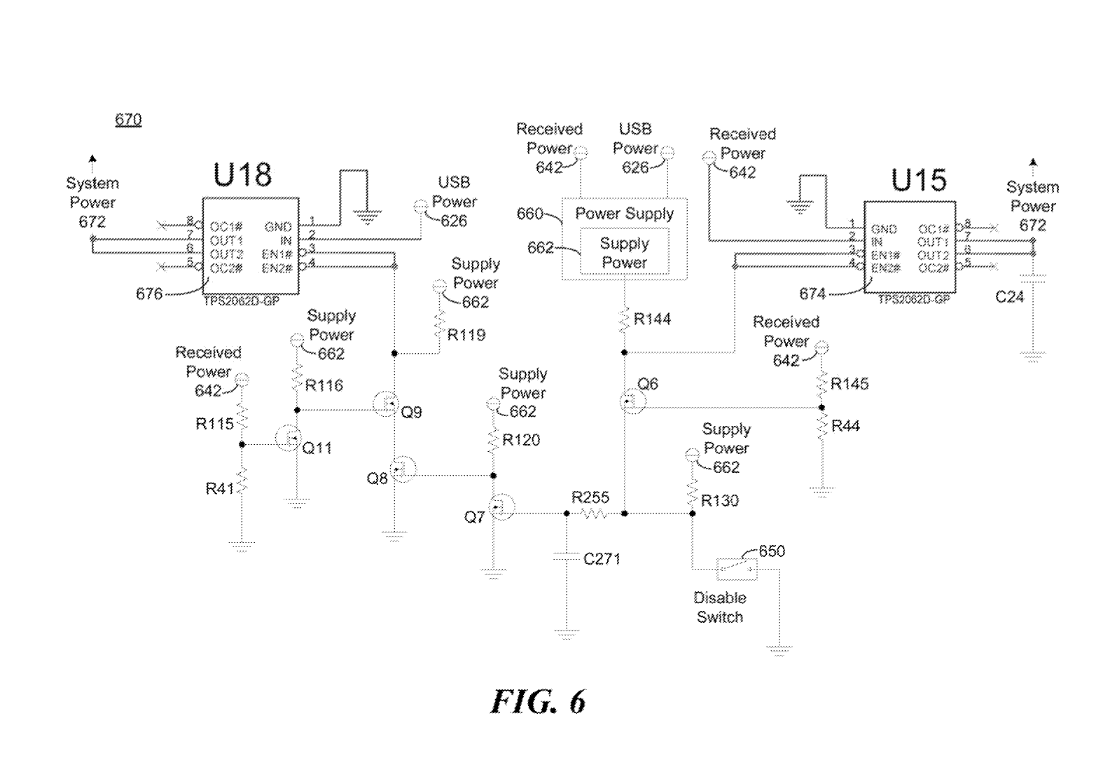

FIG. 6 is a circuit diagram of a power switch 670 according to an example wherein in one embodiment an input combination interface is associated with a USB interface and USB power. The power switch 670 may include disable switch 650, first USB power switch 674, second USB power switch 676, and power supply 660. The power switch 670 may be associated with various power sources, such as received power 642, USB power 626, and supply power 662. The power switch 670 may provide system power 672, based on the presence of USB power 626 and/or received power 642. For example, the power switch 670 may select the USB power 626 as a source of power for system power 672, unless an external power source is available (e.g., an alternating current (AC) adapter or other source to provide received power 642). If received power 642 is available, the power switch 670 may dynamically switch to the received power 642 as a source of power for system power 672.

The disable switch 650 may control whether the power switch 670 is enabled or disabled. The disable switch 650 may disable the first USB power switch 674, the second USB power switch 676, and/or the power supply 660, for example. Switching off the disable switch may prevent system power 672 from being provided to the computing device associated with the power switch 670, and may place the computing device in a low power state. Disable switch 650 may be a mechanical rocker switch, and may be implemented using other switches including non-mechanical switches.

First USB power switch 674 and second USB power switch 676 may be enabled and disabled based on whether received power 642 is applied. Enabling first USB power switch 674 may cause system power 672 to be generated based on received power 642. Enabling second USB power switch 676 may cause system power 672 to be generated based on USB power 626. In the illustrated example, first USB power switch 674 and second USB power switch 676 may be enabled based on whether enable pins (e.g., EN1# and EN2#) are pulled low (low-enable), e.g., by applying a low voltage to the enable pins. In alternate examples, first USB power switch 674 and second USB power switch 676 may be enabled by being pulled high (high-enable), with corresponding adjustments to the circuit layout and/or FET logic. In the illustrated example, the presence of received power 642 may disable second USB power switch 676 and enable first USB power switch 674, such that system power 672 is provided based on the received power 642. The absence of received power may disable first USB power switch 674 and enable second USB power switch 676, such that system power 672 is provided based on the USB power 626. First USB power switch 674 and second USB power switch 676 may be USB power switches that include internal current limiting protection. The logic of power switch 670 may prevent the first USB power switch 674 and the second USB power switch 676 from being enabled simultaneously.

The power supply 660 may be implemented as a pair of cathode connected diodes, where one diode receives received power 642, the other diode receives USB power 626, and their common cathode provides supply power 662. The power supply 660 may supply a logic high (e.g., 5 volts associated with supply power 662) whether received power 642 and/or USB power 626 is available. The supply power 662 may be applied as illustrated to various resistors, serving as a voltage pull up.

An example operation may proceed as follows, such that first USB power switch 674 and second USB power switch 676 may be enabled selectively based on whether the USB power 626 and/or the received power 642 is available based on the illustrated FET logic. The disable switch 650 is illustrated as open to disable the power switch 670. Closing the disable switch 650 may enable the power switch 670, such that the gate of Q7 is pulled low thereby turning off Q7. Turning off Q7 allows R120 to apply voltage high (supply power 662) to the gate of Q8, which turns on and provides a path to ground for Q9 (and second USB power switch 676). Q9 is controlled by Q11, and Q11 is controlled by whether R115 receives voltage high from received power 642. When received power 642 is not applied to R115, Q11 is off, thereby turning on Q9 based on voltage high from R116 via supply power 662. When Q9 is on, it allows a path (through Q8) to ground, thereby pulling down the enable pins of second USB power switch 676 and enabling second USB power switch 676. Thus, system power 672 is provided based on USB power 626, in the absence of received power 642.

When received power 642 is present, Q11 is turned on, such that the gate of Q9 is pulled low thereby turning off Q9 and removing a path to ground for the enable pins of the second USB power switch 676. The enable pins of the second USB power switch 676 are pulled high by R119 applying supply power 662, and the second USB power switch 676 is disabled and does not provide system power 672 based on USB power 626. As to the first USB power switch 674, the presence of received power 642 causes Q6 to turn on (via voltage high from received power 642 through R145), providing a path to ground (through the closed disable switch 650) for the enable pins of the first USB power switch 674. Thus, the first USB power switch 674 is enabled to provide system power 672 based on received power 642.

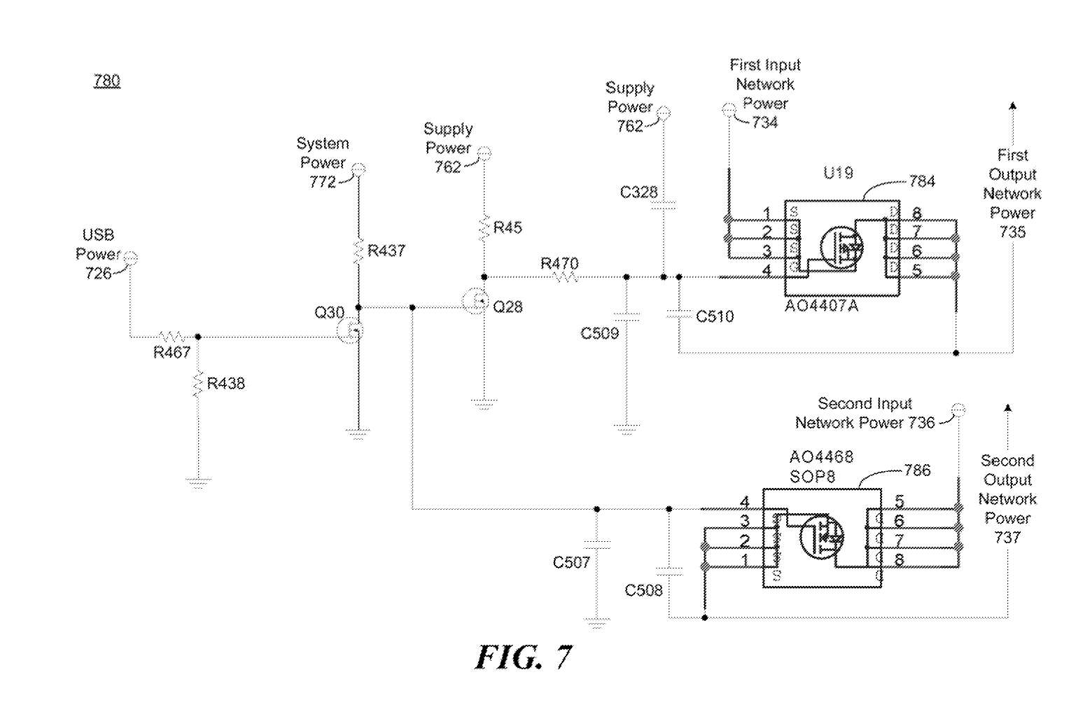

FIG. 7 is a circuit diagram of a network switch 780 according to an example wherein an input combination interface is associated with a USB interface and USB power. The network switch 780 may include a first FET switch 784 and a second FET switch 786. The first FET switch 784 may receive first input network power 734 and selectively provide a first output network power 735. The second FET switch 786 may receive second input network power 736 and selectively provide a second output network power 737. The first FET switch 784 and the second FET switch 786 may be enabled and disabled based on whether USB power 726 is provided (e.g., whether a voltage high is applied by USB power 726). For example, USB power 726 may be based on a voltage or other indication of usage at an input combination interface (e.g., USB interface) of a computing device.

The first output network power 735 and the second output network power 737 may selectively be supplied to power to a network interface of the computing device (e.g., see LAN 538 and PHY 539 of FIG. 5). In the presence of USB power 726, a gate of Q30 is pulled high, turning on Q30 and providing a path to ground for the gate of Q28. When the gate of Q28 is pulled low, the gate of second FET switch 786 also is pulled low, turning off second FET switch 786 and disabling second output network power 737. When the gate of Q28 is pulled low and Q28 is off, supply power 762 may be applied to the gate of first FET switch 786, thereby turning off the first FET switch 784 (operation of the first FET switch 784 is based on P-channel operation, in contrast to the N-channel operation of the second FET switch 786). Thus, first output network power 735 and second output network power 737 are disabled when voltage high is applied based on USB power 726, which may disable a network interface of the computing device when usage/a connection/voltage is established. In the absence of the USB power 726, Q30 is off based on its gate being pulled low by R438. Q30 being off allows the gate of Q28 to be pulled high by system power 772, turning on the second FET switch 786 (enabling second output network power 737) and Q28. Q28 being on pulls low the gate of the first FET switch 784, enabling first output network power 735. Thus, in the absence of USB power 726, a network interface of the computing device may be enabled.

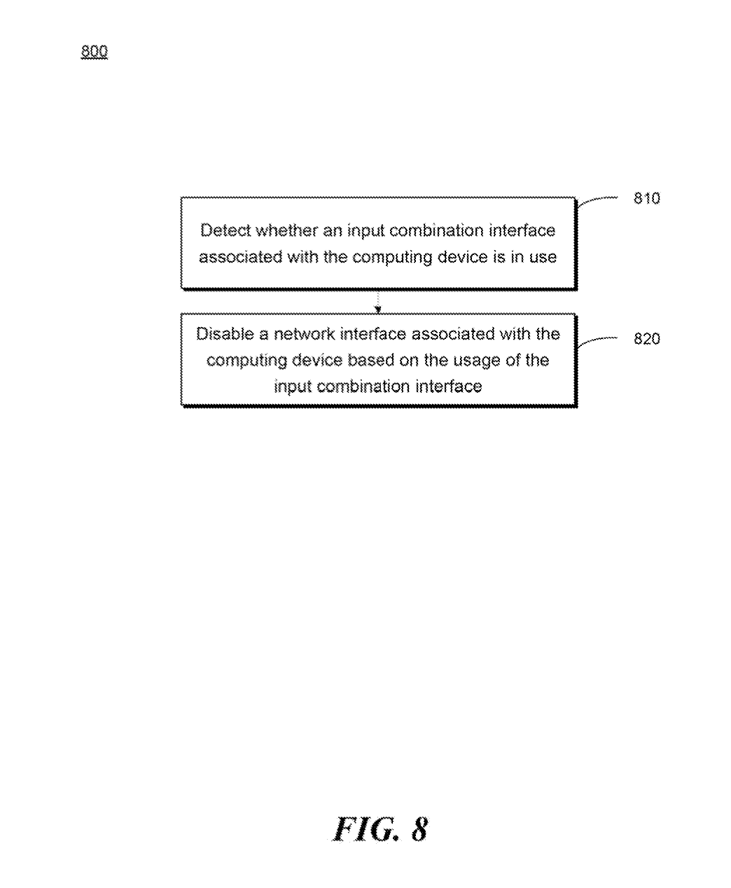

FIG. 8 is a flow chart 800 based on a method of operating a computing device according to an example. In step 810, a computing device may detect whether an input combination interface associated with the computing device is in use. For example, a switching circuit of the computing device may detect whether an input combination interface is being used. Usage may include detection of a voltage, power, data, physical presence, or other indication associated with the input combination interface. In step 820, the computing device may disable a network interface associated with the computing device based on the usage of the input combination interface. For example, the computing device may be coupled to another device via the input combination interface, enabling the computing device to receive combination interface power from the other device via the input combination interface. The computing device may also receive data from the other device via the input combination interface, and therefore may disable the network interface in order to conserve resources and remain well within a specified power envelope (e.g., a power envelope associated with the combination interface power).

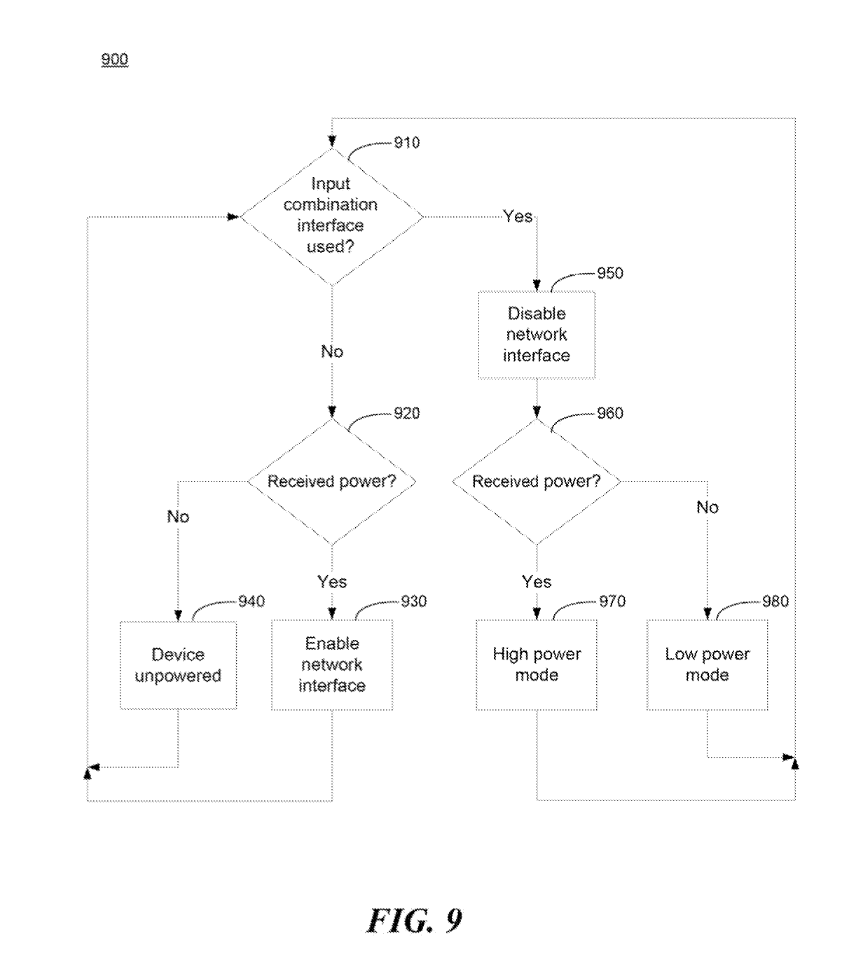

FIG. 9 is a flow chart 900 based on a switching circuit according to an example. In step 910, the switching circuit determines whether an input combination interface is used. For example, the usage may be determined based on the presence of a DC voltage at a USB interface. The usage also may be determined based on a data connection between a computing device and another device such as a host server, and may be determined by detecting a physical presence of a plug and/or using other techniques. In step 920, the switching circuit determines if received power is detected. For example, whether power is provided to a power interface. If no received power is detected, the switching circuit and/or computing device is unpowered as indicated in step 940. If received power is detected in step 920, the switching circuit enables a network interface 930. The network interface may be enabled by providing power to the network interface, although other techniques may be used to disable/enable the network interface.

If input combination interface usage is established in step 910, the network interface is disabled in step 950. In step 960, the switching circuit determines if received power is detected. If received power is detected, the computing device may operate in a high power mode 970. For example, the computing device may supply high power to a processor, display, output combination interfaces, and/or other components associated with the computing device. In an example, output combination interfaces may provide 500 milliamps (mA) of current for powering a variety of devices via the output combination interfaces. If received power is not detected at step 960, the computing device may operate in a low power mode 980. For example, the computing device may limit current at output combination interfaces to 100 mA for powering low power devices such as a keyboard and mouse. Flow chart 900 returns to step 910 to check if the input combination interface is used. Flow chart 900 may also include a step to check whether a disable switch is open to disable the computing device.

The breadth and scope of the present invention should not be limited by any of the above-described examples, but should be defined in accordance with the following claims and their equivalents.

What is claimed is:

1. A computing device comprising:
an input combination interface;
a network interface; and
a switching circuit to disable the network interface based on detection of usage of the input combination interface.

2. The computing device of claim 1, wherein the input combination interface is to receive data and power.

3. The computing device of claim 1, wherein the input combination interface is an input Universal Serial Bus (USB) interface, and the switching circuit is to detect usage of the input USB interface based on a USB voltage received by the input USB interface.

4. The computing device of claim 1, further comprising a power interface to receive power for the switching circuit to provide power to the computing device.

5. The computing device of claim 3, further comprising an output combination interface to operate in a high power mode responsive to the power interface receiving power.

6. A computing device comprising:
an input combination interface;
a network interface;
a power interface to receive power; and
a switching circuit to enable the network interface based on detection of the received power and absence of usage of the input combination interface, and disable the network interface based on detection of usage of the input combination interface.

7. The computing device of claim 6, wherein the switching circuit is to provide power to the network interface based on combination interface power from the input combination interface, in response to detection of an absence of the received power at the power interface.

8. The computing device of claim 6, wherein the switching circuit is to provide power based on the received power from the power interface, without drawing power from the input combination interface in order to provide power.

9. The computing device of claim 6, further comprising a power supply to provide power based on at least one of the combination interface power and the received power.

10. The computing device of claim 6, further comprising a disable switch to disable the network interface and the switching circuit.

11. A method of operating a computing device comprising:
detecting whether an input combination interface associated with the computing device is in use; and
disabling a network interface associated with the computing device based on the usage of the input combination interface.

12. The method of claim 11, further comprising detecting received power associated with a power interface of the computing device, and operating an output combination interface in a high power mode in response to the detecting of the received power.

13. The method of claim 12, further comprising maintaining the network interface as disabled based on the usage of the input combination interface, regardless of whether the received power is detected.

14. The method of claim 11, further comprising:
indicating, using a multifunction indicator, whether the computing device is powered by combination interface power associated with usage of the input combination interface; and
indicating, using the multifunction indicator, whether the computing device is associating with another device via an interface to exchange data.

15. The method of claim 11, wherein disabling the network interface is based on switching off power to the network interface.
